(19) United States
(12) Patent Application Publication
(10) Pub. No.: US 2008/0126491 A1
(43) Pub. Date: May 29, 2008

(54) Method for Transmitting Messages from a Sender to a Recipient, a Messaging System and Message Converting Means

(75) Inventors: Thomas Portele, Bonn (DE); David Eves, Crawley (GB); Martin Oerder, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,990

(22) PCT Filed: May 9, 2005
(86) PCT No.: PCT/IB05/51505

§ 371 Date: Nov. 13, 2006

(30) Foreign Application Priority Data
May 14, 2004 (EP) 04102140.3

(51) Int. Cl. G06F 15/16; H04L 12/58

(52) U.S. Cl. 709/206

(57) ABSTRACT

The invention describes a method for transmitting messages from a sender (5) to a recipient (6). A message is inputted in an input representation form on the sender (5) side, converted into a message in a defined transmitting representation form depending on the semantic content of the message, converted into a message in output representation form, and output in output representation form on the recipient (6) side. A semantic analysis of the message is performed within at least one of the steps converting the message in input representation form into a message in transmitting representation form and converting the message in transmitting representation form into a message in output representation form.

This invention relates to a method for transmitting messages from a sender to a recipient and to an appropriate messaging system. Further, the invention relates to message converting means.

The popularity of text-based messaging services has increased immensely since their introduction a few years ago. The widespread Short Messaging Service (SMS) is just one example of such a service. Text news systems like AOL's Instant Messenger, Microsoft's MSM Messenger and Yahoo's Messenger for PCs can be used free of charge after downloading the required free software. Some of these PC-based messaging service providers offer a voice-chat functionality in addition to the text messaging services. Furthermore, some other providers have specialised in voice chat, ultimately leading to a voice-over-IP (internet protocol) scenario.

The embedding of multimedia messaging methods in the UMTS (Universal Mobile Telecommunications System) environment, provides a further indication of the growing popularity of messaging solutions.

Disadvantages of known messaging systems are that they can only transmit a minimum of information, and are generally not easy to use. Furthermore, the available transmission data-rates are not used to the full.

Therefore, an object of the present invention is to provide a method for transmitting messages from a sender to a recipient, and an appropriate messaging system that allows an efficient and user-friendly communication.

The object of the invention is achieved by the features of the independent claims. Suitable and advantageous developments of the invention are defined by the features of the dependent claims. Further developments of the messaging system claim and the converting means claim according to the dependent claims of the method claim are also encompassed by the scope of the invention.

The present invention provides a method for transmitting messages from a sender to a recipient comprising the steps of inputting a message in input representation form on the sender side, converting the message in input representation form into a message in a defined transmitting representation form, depending on the semantic content of the message, converting the message in transmitting representation form into a message in output representation form, outputting the message in the output representation form on the recipient side, and performing a semantic analysis of the message within at least one of the two steps already described, converting the message in input representation form into a message in transmitting representation form and converting the message in transmitting representation form into a message in output representation form.

The input representation of the message might be a text typed in by means of a keyboard or keypad, or might be a spoken message in any language.

Depending at which point the converting steps are carried out, the message can be transmitted over available message channels in the input representation, the transmitting representation, or the output representation. For example, the converting steps can be carried out in full or in part in a sending device, a receiving device, or in a central communication facility. In a particularly preferred embodiment of the invention however, conversion of the input representation into the transmitting representation is carried out in a sending device, conversion of the transmitting representation into the output representation is carried out in a receiving device, and the message is transmitted in its transmitting representation via message channels or transmission networks.

The transmitting representation depends on the semantic content of the message. A semantic analysis is carried out on the message, and an appropriate transmitting representation most appropriate for the semantic content of the message is defined or chosen.

For example, the message can be definitively summarized or compacted in this way, where the definitive summary or compaction as transmitting representation or partial transmitting representation depends on the semantic content of the message. Messages containing dates can be compacted differently in transmitting representations according to semantic content, i.e. they are converted into different transmitting representation: if the semantic analysis concludes that the message contains information regarding an appointment, the compacted message, i.e. the transmitting representation, will also include the date. If however, the semantic analysis concludes that the message comprises a travel report, the compacted version, i.e. the transmitting representation, will omit the date. In this way, the message can be compacted, thereby requiring less bandwidth and storage space when compared to conventional text or audio representations.

The transmitting representation can be understood to be a kind of form, where the number of fields, sequence of fields, and type of fields of the form depend on the semantic content of the message. The form is then filled with the appropriate message content extracts.

The invention allows messages to be efficiently transmitted, for example through reduced transmission capacities, without in any way complicating the communication process from the point of view of the user.

To this end, the transmitting representation and/or the output representation of the message is preferably adapted to the recipient, i.e. it is adapted to the communication capabilities or preferences of the recipient, which may be a receiving device or a receiving user. For example, the step of converting the message in input representation form into a message in transmitting representation form and/or the step of converting the message in transmitting representation form into a message in output representation form might comprise translating the message into a preferred language of the receiving user, or might be converted into a specific style more easily understood by the recipient (e.g. clear formulation if the recipient is a child, or large type on a display for a visually impaired recipient). This step can also take into consideration the output device on the receiver side (TV, PC etc.), or the output mode on the receiving side (visual, acoustic, speech, written text etc.). These features of the invention increase the receiving side comfort and, in particular, allow chats to take place between two users using different modalities (e.g. one user uses speech over the phone, the other a text-based client).

Preferably, the step of converting the message in transmitting representation form into a message in output representation is based on a text to speech conversion, so that, for example, a user driving an automobile can register a received message.

Preferably the step of converting the message in input representation into a message in transmitting representation form is based on a speech recognition. In this way, inputting the message is simplified from the point of view of the user.

The message in transmitting representation form or in output representation form is converted into a human-readable script with suitable mark-ups or markings (e.g. for an intake of breath, or a pause for reflection), so that the quality of the audio message is improved in comparison to synthetic speech. This is particularly advantageous, should the message be addressed to a larger audience.

Preferably, the output representation is also adapted to or dependent on the semantic content of the message. For example, the message can be compacted on the receiving side, where the defined summary as output representation or part of the output representation depends on the semantic content of the message.

Preferably, messages for transmission or messages that have been received are filtered/transmitted or processed/delivered according to priority, depending on the semantic content or the chosen transmitting representation. Preferably, the urgency or priority of a message is defined according to a set of rules based on the semantic content of the message (e.g. if the content has a time-limited validity, the message is sent instantly). The current user situation, particularly at the receiver side, can thereby be taken into consideration. For example, only really important messages might be forwarded to a user driving on the motorway, whereas a user in a stationary automobile can be given received messages of any priority.

In a particularly preferred embodiment of the invention, it can also be decided on the basis of the current communication situation how the message is to be presented to the recipient. For example if the recipient is currently engaged in a hands-free eyes-free activity like driving or sports, the message can be spoken. If the recipient is reading, the message can be displayed as text on the TV. If the recipient is watching TV, the message priority determines whether a short summary is presented, for example in the form of an unobtrusive scrolling banner at the bottom of the screen if the user is watching a movie or program, or maybe as a “screen within a screen” if the message arrives during a commercial break.

According to a particularly preferred embodiment, the conversion of a message in a transmitting representation and/or an output representation is based on an application which already deals with structured content. For instance, a transmitting representation could be generated from a calendar entry in an organizer application by converting the proprietary format into the transmitting representation, thereby making use of the semantic information implied within the proprietary application format. Thus, information already available in the organisation structure of the application data is put to use, in order to allow, in a simple manner, content-related conversion of a message into a transmitting representation and/or a output representation.

To assist the semantic analysis a converting step is preferably based on using dialogues between the user and the converting device (e.g. input device, sending device or transmitting device). Semantic items derived from the user input can be checked whether they really contain the intended meaning, and, in case of ambiguities, clarification questions can be asked. A final verification process can contain the rendering of the content message back to the input device or an other user-suited format like text or speech. By interacting with the converting device or the converting tool the user can correct possible errors or clarify ambiguous items, before sending the message. Preferably an automatic dialogue between the converting means and the sender is initiated to identify the semantic content of the message, if an ambiguity value of a recognition result of a automatic semantic content recognition arrangement reaches or exceeds a certain ambiguity limit.

Preferably the transmitting representation and/or the output representation is based on the emerging standard for knowledge representation on the Internet, the web ontology language OWL (http://www.w3.org/TR/owl-features/). Using this known language for the transmitting representation permits the invention to be incorporated in available communications structures so that the invention can work together with these.

Alternatively, a customised representation can be used as a transmitting representation and/or output representation. Such a specific adaptation of the transmitting representation and/or output representation to the existing communication conditions might be particularly advantageous, since the converting steps can be carried out in better quality with regard to the content preservation. It goes without saying that a parallel support of several transmitting representations and/or output representations, such as an open and a closed or dedicated one, lies within the scope of the invention.

Preferably the message is automatically supplemented or augmented, especially on the sender side, with content related information like annotated images, links, and references to earlier messages or conversations regarding the same semantic content or topic. Preferably information is added that contains indications about extra-linguistic features like mood, irony, and emphasis captured from the speaker by appropriate analyses (e.g. prosodic analysis of speech, analysis of facial expressions). An exemplary way of doing this is by inserting emoticons into a written transcript of a spoken text. To this end, expression, gesture, volume and pitch of the sending user are registered as part of the semantic content of a message, and analysed accordingly. To this end, the sending device and/or the receiving device are preferably equipped with part of a dialog system and a camera such as that described in DE 102 49 060 A1.

In addition or alternatively, the message or the content of the message can automatically be included in a content-dependent context during the conversion into a transmitting representation and/or an output representation.

Preferably the message is complemented by a service information, the service information being based on the semantic content of the message. In particular, the semantic content of the message can be forwarded during transmission to an appropriate server unit, which deduces corresponding service information from the semantic content and appends the service information to the message. For example, a query to a friend “Shall we meet at a pub tonight?” can be enhanced by information from local pubs regarding opening hours and special offers. Whether or not the message should be augmented by such service information is preferably controllable by the sender and/or the recipient, so that the users' privacy is not violated.

The object of the invention is also addressed by a messaging system comprising an input device for inputting a message in input representation form on a sender side, a transmission means for sending and receiving the message, an output device for outputting the message in output representation form on the recipient side, and a message converting means, arranged such that a message in input representation form is converted into a message in a defined transmitting representation form depending on the semantic content of the message, and that a message in transmitting representation form is converted into a message in output representation form, and that a semantic analysis of the message is performed within at least one of the steps of converting the message in input representation form into a message in transmitting representation form and converting the message in transmitting representation form into a message in output representation form.

The messaging system, in particular the message converting means, can be realised at any point between sender and recipient. It can be controlled by a service control unit, whereby users might first be obliged to register before availing of services offered by the messaging system. Such a registration can be based on a new-user authentication, requiring, for example, input of passwords, verification dialogs, validation of biometric information or hardware ID of a dedicated client. The messaging system also permits message delivery including routing, forwarding, storing, message distribution to a group of users, and content-based two-way chats and chat rooms.

The message converting means can be realised as a central communication unit of a communication network or part of such a communication unit, and operated using software controlled processing means. It goes without saying that realisation of the converting means entirely or partially in an input device and/or an output device lies within the scope of the invention.

An input or output device can be, for example, a personal computer, laptop, telephone, mobile phone, fax or home entertainment device such as a television or radio.

Other objects and features of the present invention will become apparent from the following detailed descriptions considered in conjunction with the accompanying drawings. It is to be understood, however, that the drawings are designed solely for the purposes of illustration and not as a definition of the limits of the invention.

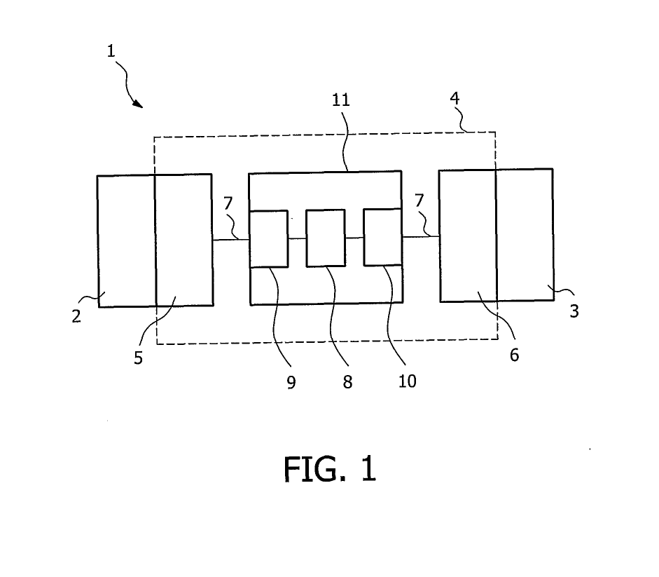

FIG. 1 is a block diagram of the system architecture of a messaging system;

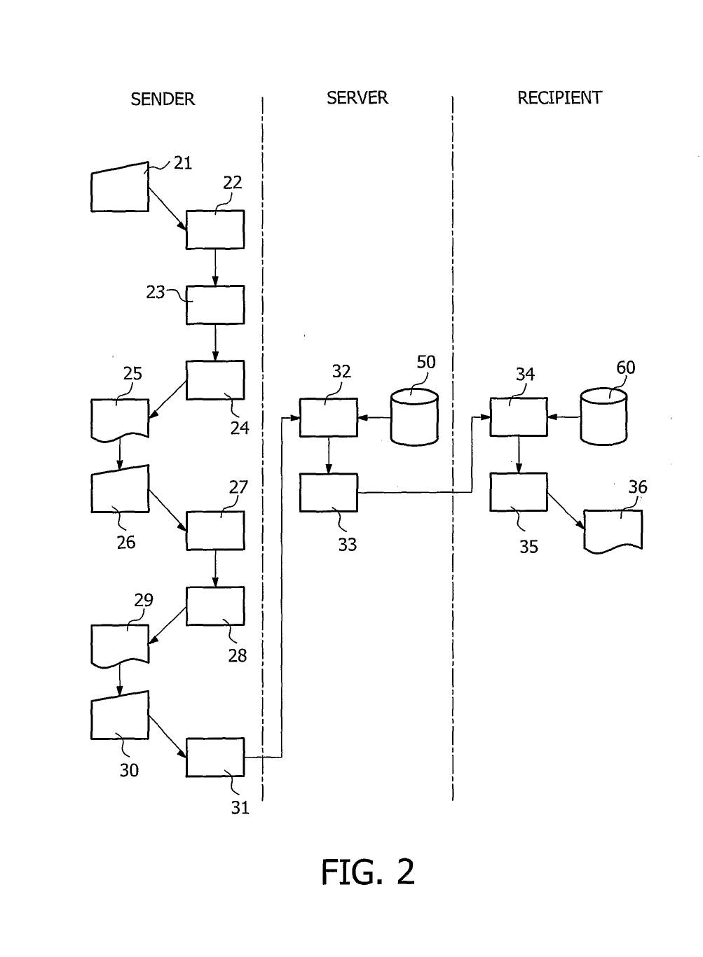

FIG. 2 is a process sequence of a method for transmitting messages.

FIG. 1 shows a messaging system 1, comprising an input device 2 and an output device 3. The input device 2 and the output device 3 are connected by a transmission means 4.

The transmission means 4 comprises a sending device 5 and a receiving device 6, connected, for the transmission of messages, by suitable wired or wireless communication channels 7. The transmission means 4 might also comprise transmission facilities or routers (not shown in the figure) for the purpose of transmitting messages.

A main component of the message converting means 11 of the messaging system is a processing means 8, to which messages are routed from the sending device 5 via an input interface 9, and which forwards the messages via an output interface 10 to the receiving device 6.

The processing means 8 can be realised as a software controlled processor, for example as part of a service computer, and can therefore be part of the transmission means 4 (for example as part of a transmission facility or an intelligent telecommunication network). Alternatively, the processing means 8 can be realised externally to the transmission means 4, and only be connected to the transmission means 4.

The input device 2 and the sending device 5 can both, for example, be realised in a communication device such as a personal computer or a mobile phone. The same applies to the output device 3 and the receiving device 6.

The input device 2 comprising, for example, a microphone, keyboard and/or camera, allows the entry of a message in input representation form by the user at the sender side. After the message in its input representation form has been transmitted by the transmission 4 means to the processing means 8, it is subjected to a semantic analysis in the processing means 8 and converted to a transmitting representation, the type of which depends on the results of the analysis, i.e. on the semantic content. The transmitting representation used in a specific transmission is therefore preferably one of several pre-defined transmitting representations. Subsequently, the message in transmitting representation form is transmitted via the transmitting means 4 to the receiving device 6, converted there by a converting means—not shown in the figure—into an output representation form, and finally output to a user on the receiving side by the output device 3, which might comprise a loudspeaker and/or a display.

Depending on the embodiment of the invention, conversion of the message from the input representation to the transmitting representation can take place on the sender's side or on the recipient's side. Equally, conversion of the message from transmitting representation into output representation can be carried out centrally by the processing means 8, or even at the sender side. The invention also allows for the case where the output representation is identical with the transmitting representation.

The messaging system can be part of a larger communication network, for example the internet, a wire line telecommunication network or a mobile telecommunication network. The user devices as well as the infrastructure of the messaging system can thereby be realised at least partially using known and available hardware elements.

FIG. 2 shows the various steps in a method for transmission of messages, whereby the left-hand side shows the sender-side steps (SENDER), the centre shows server-side steps (SERVER), and the receiver-side steps (RECIPIENT) are shown on the right-hand side.

On the sender side, the sending user first enters a spoken message by means of a microphone in step 21. The message is subject to a speech recognition procedure in step 22, in which the semantic content of the message is identified. In step 23, information regarding extra-linguistic characteristics of the user is added, obtained by a speech and/or video analysis of the expressions and gestures of the sending user.

If ambiguities are detected in the identified semantic content in step 24, a clarification question is put to the user by means of a dialog in step 25. Depending on the user's reply in step 26, the ambiguity is resolved in step 27, and the message is edited accordingly and converted into the transmitting representation form.

Subsequently, the message is shown in transmitting representation form to the user in steps 28 and 29, and, after confirmation (step 30) by the sending user, the message is forwarded to a central server computer in step 31.

In the server computer, the message is enriched with additional information in step 32, using service information retrieved from a database 50 depending on the semantic content of the message. The message is sent to the recipient in step 33.

On the recipient side, the message is rendered according to the recipient's preferences with regard to language, emotion, inclusion, style or brevity. Information regarding the preferences of the recipient can be retrieved from a database 60. In step 35, the presence and attention of the user or recipient is analysed, and, in step 36, the delivery of the message is repeated or carried out in a different manner.

In the following, a example message from Frank to Thomas “Let's meet tomorrow at 3 pm” is converted into a defined transmitting representation, based on the XML format:

<message>

<sender>

<name>Frank</name>
<address>Frank@philips.com</address>

</sender>
<recipient>

<name>Thomas</name>
<address>Thomas@philips.com</address>

</recipient>
<deliveryOptions>

<delay>none</delay>
<confidentiality>none</confidentiality>

</deliveryOptions>
<content>

<appointment>

<date>

<day>19</day>
<month>3</month>
<year>2004</year>

</date>
<time>

<hour>15</hour>
<minute>0</minute>
<second>0</second>

</time>
<place/>
<additionalInfo/>

</appointment>

</content>

</message>
The following definitions apply:
Message has
Sender
Recipient
DeliveryOptions
Content
Sender is Person
Recipient is Person
Person has
Name (Text)
Address (Text)
DeliveryOptions has
Delay (Text or Date), one of (“none”, or a date)
Confidentiality (Text), one of (“none”, “low”, “medium”, “high”,
“extreme”)
Content has (optional combination of)
Appointment
Reminder
Notification
...
Appointment has
Date
Time
Place
Invitees
Date has
Day (Number)
Month (Number)
Year (Number)
Time has
Hour (Number)
Minute (Number)
Second (Number)
Invitees has
Invitee
Invitee is Person

This implies that, depending on the semantic content of the message (appointment, reminder or notification), the transmitting representation will be changed insofar as the message only contains the content fields (appointment, reminder or notification) required for description of the contents.

For the sake of clarity, it is also to be understood that the use of “a” or “an” throughout this application does not exclude a plurality, and “comprising” does not exclude other steps or elements. A “unit” or “module” may comprise a number of blocks or devices, unless explicitly described as a single entity.

1. Method for transmitting messages from a sender (5) to a recipient (6) comprising the steps of:
inputting a message in input representation form on the sender (5) side,
converting the message in input representation form into a message in a defined transmitting representation form, which depends on the semantic content of the message,
converting the message in transmitting representation form into a message in output representation form,
outputting the message in output representation form on the recipient (6) side,
performing a semantic analysis of the message within at least one of the steps converting the message in input representation form into a message in transmitting representation form and converting the message in transmitting representation form into a message in output representation form.

2. Method according to claim 1, in which at least one of the representations transmitting representation and output representation is adapted to the recipient (6).

3. Method according to claim 1, in which supplementary information is automatically added to the message, the supplementary information being dependent on the semantic content of the message.

4. Method according to claim 1, in which the semantic analysis is automatically supplemented by a dialogue with the user, if the result of the semantic analysis is ambiguous.

5. Method according to claim 1, in which the step of converting the message into a message in a defined transmitting representation form or into a message in output representation form is based on a defined representation of an application.

6. Method according to claim 1, in which the transmitting representation is based on a web ontology language.

7. Method according to claim 1, in which the step of converting the message in input representation form into a message in transmitting representation form is based on a speech recognition.

8. Method according to claim 1, in which the step of converting the message in transmitting representation form into a message in output representation form is based on a text to speech conversion.

9. Messaging system (1) comprising
an input device (2) for inputting a message in input representation form on a sender (5) side,
transmission means (4) for sending and receiving the message,
an output device (3) for outputting the message in output representation form on the recipient (6) side and
message converting means (11), that are arranged such,
that a message in input representation form is converted into a message in a defined transmitting representation form depending on the semantic content of the message,
that a message in transmitting representation form is converted into a message in output representation form, and
that a semantic analysis of the message is performed within at least one of the steps converting the message in input representation form into a message in transmitting representation form and converting the message in transmitting representation form into a message in output representation form.

10. Message converting means (11) comprising
an input interface (9) for receiving a message in input representation form,
an output interface (10) for sending the message in output representation form, and
processing means (8) that are arranged such,
that a message in input representation form is converted into a message in a defined transmitting representation form depending on the semantic content of the message,
that a message in transmitting representation form is converted into a message output representation form, and
that a semantic analysis of the message is performed within at least one of the steps converting the message in input representation form into a message in transmitting representation form and converting the message in transmitting representation form into a message in output representation form.
